(19) United States
(12) Patent Application Publication
(10) Pub. No.: US 2001/0017601 A1
(43) Pub. Date: Aug. 30, 2001

(54) Waterproofing and gas-permeable case construction of satellite- broadcast receiving converter

(75) Inventor: Tomoki Ikeda, Fukushima-ken (JP)

Correspondence Address: BRINKS HOFER GILSON & LIONE, P.O. Box 10395, Chicago, IL, 60610, US

(73) Assignee: Alps Electric Co., Ltd.

(21) Appl. No.: 09/791,069

(22) Filed: Feb. 22, 2001

(30) Foreign Application Priority Data
Feb. 25, 2000 (JP) 2000-054351

(51) Int. Cl. H01Q 19/12

(52) U.S. Cl. 343/840

(57) ABSTRACT

According to a case construction of the satellite-broadcast receiving converter of the present invention, air from the outside can enter and exit from a housing through a filter by way of a hole. Accordingly, a case and a sealing member can be prevented from being destroyed because of the expansion and contraction of air in the housing and, at the same time, water such as rain entering a cavity through the hole can be prevented from entering the housing deeper by the filter.

### BACKGROUND OF THE INVENTION

1. Field of the Invention

The present invention relates to a waterproofing case construction of a satellite-broadcast receiving converter.

2. Description of the Related Art

Referring to FIG. 9, a conventional case construction of a satellite-broadcast receiving converter will be described. The satellite-broadcast receiving converter 21 comprises a body 23 including a cabinet 22, etc. in which a receiving circuit is accommodated, and a coaxial connector 24 mounted to the body 23 to take electric signals out.

A case 25 comprises a first and second molded case members 26, 27 made of synthetic resin. With the body 23 being accommodated in the housing 25a, which is formed by combining the first and second case members 26, 27, the connector 24 is provided so as to project outwardly through a hole 26a of the first case member 26. Further, the case is so constructed that the hole 26a between the connector 24 and the first case 26 is filled with a sealing member 28, the housing 25a made up of the first and second cases 26, 27 is completely sealed, and the air does not flow into the housing 25a from the outside.

Thus, by completely sealing the housing 25a in the case 25, water is prevented from entering the housing 25a from the outside.

The satellite-broadcast receiving converter having such construction is brought into an inspection device, and the pressure of the air in the inspection device is increased or reduced to check if the housing 25a of the case 25 has leakage of air.

Then, the accepted satellite-broadcast receiving converter under the inspection is put on the market, set outdoors, and used.

However, when a satellite-broadcast receiving converter with the housing 25a completely sealed is used outdoors, particularly in summer, at high outdoor temperatures, the air inside the housing 25a would expand to destroy the case 25 or the sealing member 28.

The conventional satellite-broadcast receiving converter is so constructed as to completely seal the housing 25a of the case 25. Therefore, it has such problems that, particularly in summer, when the outdoor temperature gets higher, the air inside the housing 25a expands and destroys the case 25 or the sealing member 28.

### SUMMARY OF THE INVENTION

It is therefore an object of the present invention to provide a case construction of a satellite-broadcast receiving converter in which the case or the sealing member is not destroyed and waterproofing of the housing is possible.

As a first solving means to solve the above problems, the case construction of a satellite-broadcast receiving converter comprises a satellite-broadcast receiving converter having a body and a connector, and a case having a housing to accommodate the body; wherein the connector of the satellite-broadcast receiving converter projects outwardly from the case while an entire portion of the body being covered with the case, a portion of the case includes a cavity provided between an inner part and an outer part of the case, a closing part so formed as to close the outer part of the cavity and a hole so made in the closing part as to provide communication between the outside of the case and the cavity, and the inner part of the cavity is closed with a waterproofing and gas-permeable filter.

Further, as a second solving means, the filter is disposed so as not to oppose a face of the closing part.

Further, as a third solving means, the closing part is formed of a thin wall.

Further, as a fourth solving means, the closing part is formed on the outer surface of the case and the filter is provided on the inner surface of the case.

Further, as a fifth solving means, the filter is affixed to the case by adhesive.

Further, as a sixth solving means, the filter is supported by a cabinet making up the body of the satellite-broadcast receiving converter.

Further, as a seventh solving means, a face of the closing part is disposed perpendicularly to the projecting direction of the connector from the case.

Further, as an eighth solving means, the closing part is positioned in the vicinity of the connector.

### BRIEF DESCRIPTION OF THE DRAWINGS

FIG. 1 is a front view of a case construction of a satellite-broadcast receiving converter of the invention according to a first example.

FIG. 2 is a side view of the case construction of the satellite-broadcast receiving converter of the invention according the first example.

FIG. 3 is a reverse-side view of the case construction of the satellite-broadcast receiving converter of the invention according to the first example.

FIG. 4 is an underneath view of the case construction of the satellite-broadcast receiving converter of the invention according to the first example.

FIG. 5 is a sectional view of a principal part of the case construction, as viewed sideways, of the satellite-broadcast receiving converter of the invention according to the first example.

FIG. 6 is an enlarged sectional view of a principal part of A-portion of FIG. 5.

FIG. 7 is an enlarged sectional view of a principal part of a case construction of a satellite-broadcast receiving converter of the invention according to a second example.

FIG. 8 is an enlarged sectional view of a principal part of a case construction of a satellite-broadcast receiving converter of the invention according to a third example.

FIG. 9 is a sectional view of a principal part showing a case construction of a conventional satellite-broadcast receiving converter.

### DESCRIPTION OF THE PREFERRED EMBODIMENT

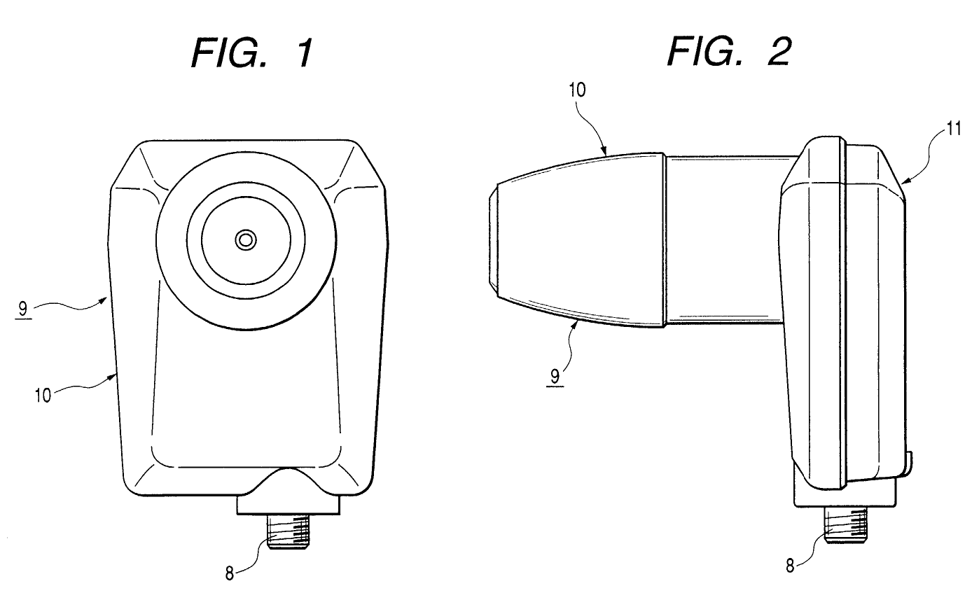

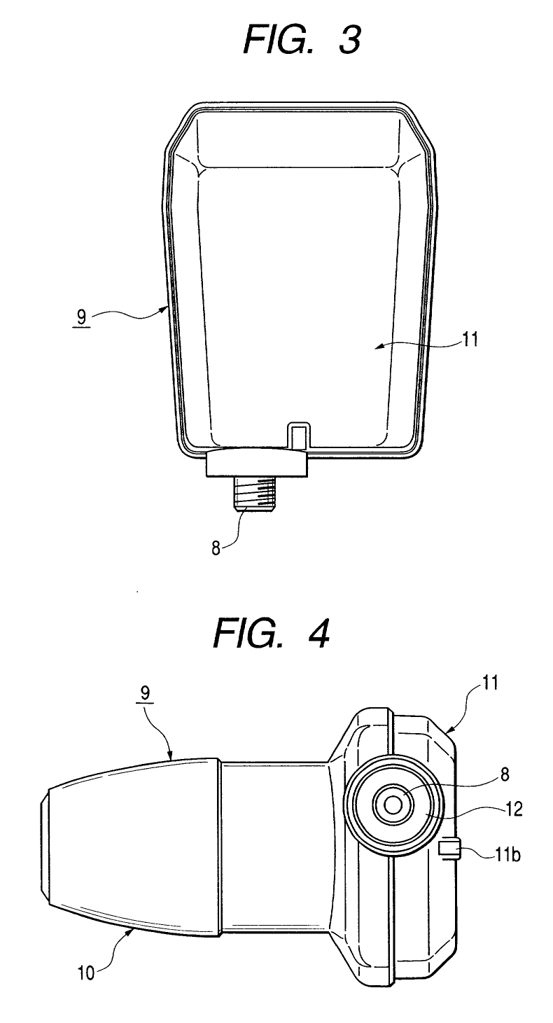

Now, the drawings for a case construction of a satellite-broadcast receiving converter of the present invention will be described. FIG. 1 is a front view of a case construction of a satellite-broadcast receiving converter according to a first example. FIG. 2 is a side view of the case construction of the satellite-broadcast receiving converter of the invention according to the first example. FIG. 3 is a reverse-side view of the case construction of the satellite-broadcast receiving converter of the invention according to the first example. FIG. 4 is an underneath view of the case construction of the satellite-broadcast receiving converter of the invention according to the first example.

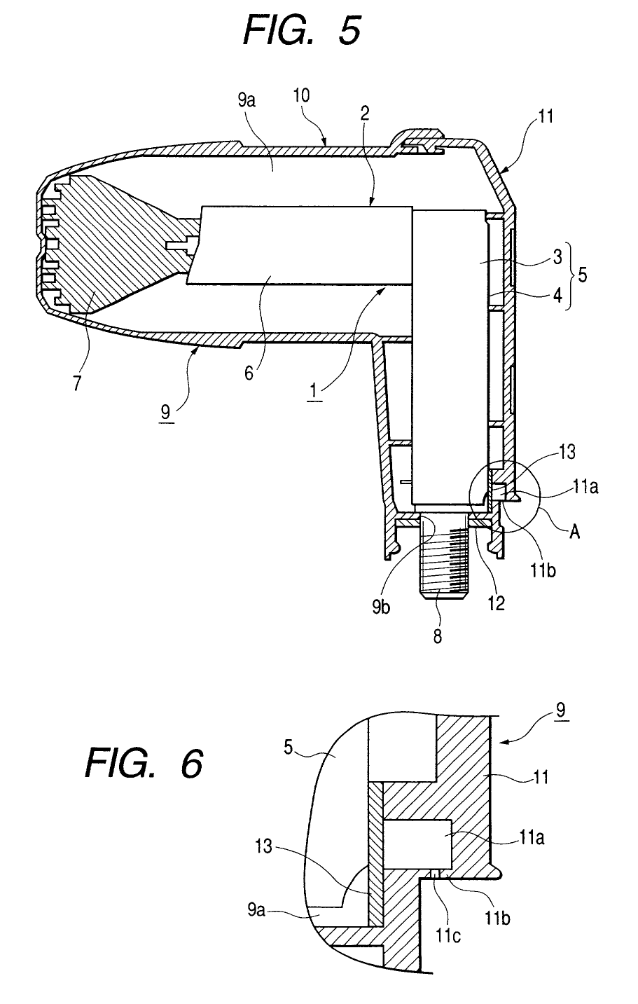

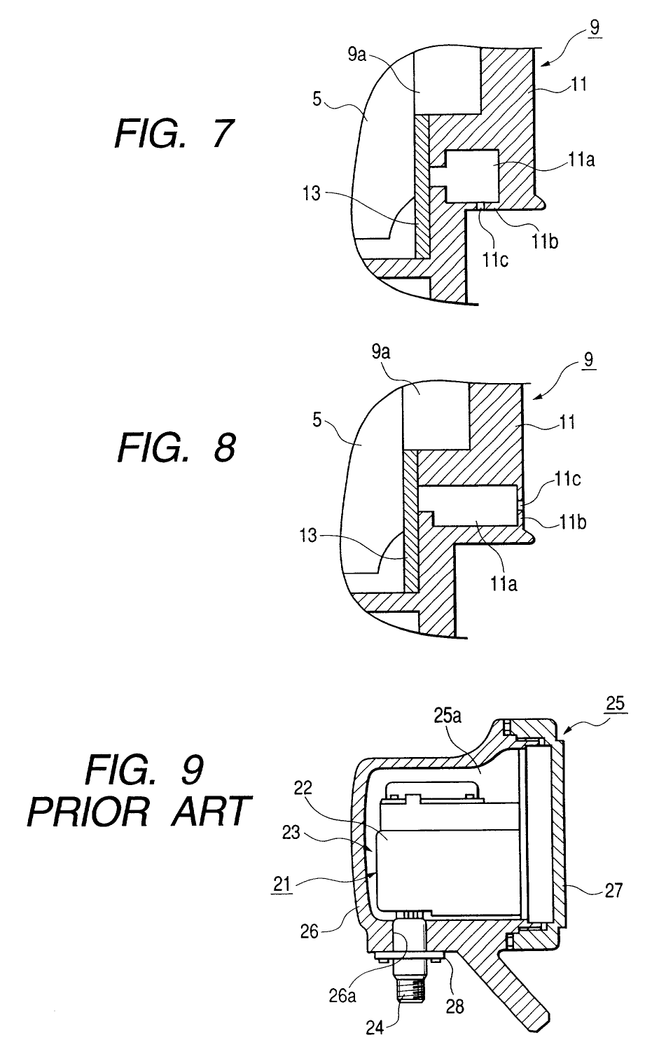

Further, FIG. 5 is a sectional view of a principal part of the case construction, as viewed sideways, of the satellite-broadcast receiving converter of the invention according to the first example. FIG. 6 is an enlarged sectional view of a principal part of A-portion of FIG. 5. FIG. 7 is an enlarged sectional view of a principal part of a case construction of a satellite-broadcast receiving converter of the invention according to a second example. FIG. 8 is an enlarged sectional view of a principal part of a case construction of a satellite-broadcast receiving converter of the invention according to a third example.

Referring to FIGS. 1 to 6, the first example of the case construction of the satellite-broadcast receiving converter of the invention will be described. The satellite-broadcast receiving converter 1 comprises a body 2 and a coaxial connector 8 mounted to the body 2.

The body 2 comprises a frame 3 made up of a metal plate and a cover 4 made up of a metal plate. It further comprises a box-shaped cabinet 5 accommodating a receiving circuit, a tubular waveguide 6 projecting perpendicularly from the cabinet 5, and a feeder 7 made of an insulating material mounted on a tip of the waveguide 6.

The coaxial connector 8 is mounted to an end face of the cabinet 5 so as to take electric signals out.

The case 9 comprises a first and second molded case members 10, 11 made of synthetic resin. Further, with the body 2 being accommodated in the housing 9a, which is formed by combining the first and second case members 10, 11, the connector 8 is provided so as to project outwardly through a hole 9b in the case 9.

The first case member 10 covers the feeder 7, the waveguide 6 and a front portion of the cabinet 5, and the second case member 11 covers a rear portion of the cabinet 5. Further, the hole 9a between the connector 8 and the case 9 is filled with the sealing member 12, and the housing 9a made up of the first and second case members 10, 11 is sealed.

Further, a portion of the second case member 11 includes a cavity 11a provided between an inner part or the housing 9a of the case 9 and an outer part or an outer portion of the case 9, and a closing part 11b made up of a thin wall provided so as to close the outer part of the cavity 11a.

Further, the closing part 11b is provided in the vicinity of the connector 8 and on the outer surface of the second case member 11. Also, a face of the closing part 11b is disposed perpendicularly to the projecting direction of the connector 8 of the case 9.

The filter 13 is made of waterproofing and gas-permeable material such as, for example, a porous material made of polytetrafluoro-ethylene resin. Adhesive (not shown) is applied on one face of the filter 13, and the filter is affixed to the inner surface of the case 9, or the inner side of the cavity 11a, in such a way that it closes the cavity 11a.

Then, the inner surface of the affixed filter 13 is in contact with the cabinet 5, and the filter 13 is supported while being pressed to the case 9 by the cabinet 5.

The face with an affixed filter 13 closing the cavity 11a and the closing part 11b provided outside are disposed perpendicularly with each other, and the filter 13 is disposed so as not to oppose the face of the closing part 11b.

Then, a small hole 11c is made in the closing part 11b made up of a thin wall with a pointed jig (not shown) . Thus, the outside of the case 9 and the cavity 11a are in communication through the hole 11c.

Since the filter 13 is disposed so as not to oppose the face of the closing part 11b, the jig does not contact the filter 13 when a hole is opened with it. Therefore, the filter 13 is prevented from being damaged by the jig.

Further, because of the hole 11c, air from the outside can enter and exit from the housing 9a through the filter 13. Accordingly, the case 9 and the sealing member 12 can be prevented from being destroyed by the expansion and contraction of the air in the housing 9a. Also, water such as rain entering the cavity 11a through the hole 11c is prevented from entering the housing 9a by the filter 13.

Further, in the case when the hole 11c is not provided, the case is constructed such that the housing 9a is completely sealed and the exterior air does not enter the housing 9a.

In an inspection process, a satellite-broadcast receiving converter, of which case is without the hole 11c, is brought into an inspection device. Then, by increasing and reducing the pressure to the air in the inspection device, leakage of air in the housing 9a of the case 9 is checked.

A small hole 11c is made by a jig in the closing part 11b of the accepted satellite-broadcast receiving converter under the inspection so that the air can freely move between the housing 9a and the outside through the filter 13.

Thus, in the case of using the satellite-broadcast receiving converter outdoors, even when air in the housing 9a expands, particularly in summer, the air moves through the hole 11c in the filter 13 to prevent the case 9 and the sealing member 12 from being destroyed. Also, the housing 9a can be waterproofed by means of the filter 13.

When setting the satellite-broadcast receiving converter 1 outdoors, the feeder 7 is mounted so as to face the direction of a satellite with the connector 8 underside. Therefore, if the face of the closing part 11b is provided perpendicularly to the projecting direction of the connector 8 of the case 9, the closing part 11b is positioned underside, preventing water such as rain from entering deeper through the hole 11c.

FIG. 7 shows a second example of the present invention. In the example, the inner part of the cavity 11b closed by the filter 13 is made small to prevent the entering water in the cavity 11b from reaching the filter 13 directly. Since the rest of the construction is similar to the example described above, like numbers are given to like parts and the description for them is omitted here.

FIG. 8 shows a third example of the present invention. In the example, the filter 13 and the closing part 11b are opposed across the cavity 11a. In the rest of the construction, like numbers are given to like parts of the first example and the description for them is omitted here.

The case construction of the satellite-broadcast receiving converter according to the present invention comprises a cavity 11a provided in a portion of the case 9 between the inner part and the outer part of the case 9, a closing part 11b formed so as to close the outer part of the cavity 11a, and a hole 11c made in the closing part 11b to provide communication between the outside of the case 9 and the cavity 11a. Also, the inner part of the cavity 11a is closed by the filter 13, which is both waterproofing and gas-permeable and, by way of the hole 11c, the air from the outside can enter and exit from the housing 9a through the filter 13. Thus, the case 9 and the sealing member 12 are prevented from being destroyed by the expansion and contraction of the air in the housing 9a and, at the same time, water such as rain entering the cavity 11a through the hole 11c is prevented from entering the housing 9a by the filter 13.

Also, according to the construction such as described above, without altering the inspection method, leakage of air in the housing 9a of the case 9 can be checked by using a conventional inspection device.

Further, since the filter 13 is disposed so as not to oppose the face of the closing part 11b, a jig does not contact the filter 13 when making a hole 11c in the closing part 11b with it, and the filter 13 can be provided without being damaged by the jig.

Further, since the closing part 11b is formed of a thin wall, it is easy to make a hole 11c in it and the one with good workability can be provided.

Further, since the closing part 11b is formed on the outer surface of the case 9 and the filter 13 is provided on the inner surface, a distance between the filter 13 and the closing part 11b can be made long enough, and the filter 13 without being damaged by the jig can be provided.

Further, since the filter 13 is affixed to the case 9 by adhesive, mounting of the filter 13 is easy and, at the same time, the housing 9a adequately sealed by the filter 13 can be provided.

Further, since the filter 13 is supported by the cabinet 5 making up the body 2 of the satellite-broadcast receiving converter 1, the filter 13 is prevented from coming off so that the filter 13 which does not peel off for a long time can be provided.

Further, since the face of the closing part 11b is disposed perpendicularly to the projecting direction of the connector 8 from the case 9, the closing part 11b is positioned underside. Therefore, the construction in which water such as rain via the hole 11c is prevented from entering deeper can be provided.

Further, since the closing part 11b is provided in the vicinity of the connector 8, the closing part 11b is close to the lowest portion of the case 9. Thus, the construction in which water such as rain via the hole 11c is prevented from entering deeper can be provided.

What is claimed is:

1. A case construction of a satellite-broadcast receiving converter, comprising: a satellite-broadcast receiving converter having a body and a connector, and a case having a housing to accommodate the body;
wherein the connector of the satellite-broadcast receiving converter projects outwardly from the case while an entire portion of the body being covered with the case, a portion of the case includes a cavity provided between an inner part and an outer part of the case, a closing part so formed as to close the outer part of the cavity and a hole so made in the closing part as to provide communication between the outside of the case and the cavity, and the inner part of the cavity is closed with a waterproofing and gas-permeable filter.

2. A case construction of a satellite-broadcast receiving converter according to claim 1, wherein the filter is disposed so as not to oppose a face of the closing part.

3. A case construction of a satellite-broadcast receiving converter according to claim 1, wherein the closing part is formed of a thin wall.

4. A case construction of a satellite-broadcast receiving converter according to claim 1, wherein the closing part is formed on the outer surface of the case and the filter is provided on the inner surface of the case.

5. A case construction of a satellite-broadcast receiving converter according to claim 1, wherein the filter is affixed to the case by adhesive.

6. A case construction of a satellite-broadcast receiving converter according to claim 5, wherein the filter is supported by a cabinet making up the body of the satellite-broadcast receiving converter.

7. A case construction of a satellite-broadcast receiving converter according to claim 1, wherein a face of the closing part is disposed perpendicularly to the projecting direction of the connector from the case.

8. A case construction of a satellite-broadcast receiving converter according to claim 7, wherein the closing part is positioned in the vicinity of the connector.
